(19) United States
(12) Patent Application Publication
(10) Pub. No.: US 2024/0052181 A1
(43) Pub. Date: Feb. 15, 2024

(54) FLAME RESISTANT COMPOSITIONS FOR ADDITIVE MANUFACTURING AND ASSOCIATED PRINTED 3D ARTICLES COMPRISING EXPANDABLE GRAPHITE

(71) Applicant: 3D Systems, Inc., Rock Hill, SC (US)

(72) Inventors: Meisam Shir MOHAMMADI, Rock Hill, SC (US); Khalil MOUSSA, Rock Hill, SC (US); Zezette PFLAUM, Rock Hill, SC (US)

(21) Appl. No.: 18/448,551

(22) Filed: Aug. 11, 2023

Related U.S. Application Data
(60) Provisional application No. 63/443,176, filed on Feb. 3, 2023.
(60) Provisional application No. 63/397,587, filed on Aug. 12, 2022.

(51) Int. Cl. C09D 5/18; C09K 21/02; C09D 5/03; C09D 7/61; C09D 7/40; C09D 177/02; B33Y 70/00

(52) U.S. Cl. CPC C09D 5/185; C09K 21/02; C09D 5/033; C09D 5/031; C09D 7/61; C09D 7/69; C09D 177/02; B33Y 70/00; C08K 7/24

(57) ABSTRACT

Compositions for additive manufacturing applications are described herein which, in some embodiments, impart flame resistant and/or flame retardant properties to articles printed or formed from the compositions. The compositions may also impart desirable mechanical properties to the articles. In some embodiments, a composition comprises a sinterable powder or a thermoplastic polymer in an amount of 10-99 wt. %, based on the total weight of the composition, and an expandable graphite component in an amount of up to 20 wt. %, based on the total weight of the composition. In some instances, the expandable graphite component is in its free form or encapsulated in material.

### CROSS REFERENCE TO RELATED APPLICATIONS

This application claims priority pursuant to 35 U.S.C. § 119 to U.S. Provisional Patent Application No. 63/397,587, filed Aug. 12, 2022, and to U.S. Provisional Patent Application No. 63/443,176, filed Feb. 3, 2023, each of which is hereby incorporated by reference in its entirety.

### FIELD

The present invention relates to compositions for additive manufacturing and, in particular, to compositions imparting flame resistant or flame retardant properties to articles printed or formed from the compositions.

### BACKGROUND

Three-dimensional (3D) printers and systems employ materials of various kinds to form various 3D objects, articles, or parts in accordance with computer generated files. Such materials can include build materials used to form the objects themselves, as compared to sacrificial support materials which may be used to support an object during the additive manufacturing process but which are subsequently removed from the final printed object. Some build materials are also known as inks, for example in the case of polymerizable liquids or other fluids that are jetted or otherwise selectively deposited to form a 3D object. In some such instances, the build material is solid at ambient temperatures and converts to liquid at elevated jetting temperatures. In other instances, the build material is liquid at ambient temperatures. Build materials can also be powders or dry particulate materials, as opposed to polymerizable liquids. Such powders may be used in selective laser sintering (SLS) and similar additive manufacturing techniques.

Build materials can comprise a variety of chemical species. Chemical species to include in a build material can be selected according to various considerations including, but not limited to, desired chemical and/or mechanical properties of the printed article and operating parameters of the 3D printing apparatus or system. Unfortunately, some build materials and resultant articles printed from the build materials can be unsuitable for electronics and transportation applications and/or other applications necessitating flame resistance. As a result, 3D printing technology may find limited application in fields requiring flame resistant or flame retardant materials and articles, and there is a need for improved materials for forming flame resistant or flame retardant articles by additive manufacturing.

### SUMMARY

In view of the foregoing, compositions (or build materials) for additive manufacturing applications are described herein which, in some embodiments, impart flame resistant and/or flame retardant properties to articles printed or formed from the compositions. The compositions may also impart or preserve desirable mechanical properties to the articles. In some embodiments, a composition described herein comprises a sinterable powder in an amount of 10-99 wt. %, based on the total weight of the composition, and an expandable graphite component in an amount of up to 20 wt. %, based on the total weight of the composition. In some instances, the expandable graphite component comprises, consists of, or consists essentially of expandable graphite in its free form. In other embodiments, the expandable graphite component comprises, consists of, or consists essentially of expandable graphite coated with or encapsulated in material, as described further hereinbelow. Moreover, in some cases, the expandable graphite component of a composition described herein is a particulate material having a certain average particle size and/or roundness or flowability, as described further hereinbelow. Such particle characteristics, in some cases, can provide advantages in an additive manufacturing process and/or impart improved properties to a printed article, as described further herein.

The sinterable powder of a composition described herein, in some cases, comprises a semicrystalline polymer, including as a primary or majority component in some instances. For example, in some embodiments, the sinterable powder comprises a polyamide (PA), a polyester (PEs), a polyurethane (PU), a polyethyelene (PE), a polypropylene (PP), a poly(butylene terephthalate) (PBT), a poly(etheretherketone) (PEEK), a poly(etherketoneketone) (PEKK), or a combination of two or more of the foregoing. A sinterable powder described herein, in some embodiments, further comprises a filler component or filler material, such as glass, ceramic, or carbon fiber.

Moreover, in some cases, a composition described herein is free or substantially free of phosphate.

Some compositions described herein are particularly suited for forming 3D articles using SLS and other additive manufacturing techniques employing a powder or dry particulate build material. However, compositions and methods described herein are not necessarily limited to SLS or other sintering applications or uses. The present disclosure also contemplates compositions and methods of forming articles using other additive manufacturing techniques. For example, in some instances, compositions and methods for fused deposition modeling (FDM) are also described. In such embodiments, the sinterable powder described above can be replaced with a different material, such as a thermoplastic polymer that can be extruded, jetted, or otherwise deposited in a layer-by-layer manner to form a 3D article.

Therefore, in some cases, a composition for additive manufacturing is described herein, wherein the composition comprises a thermoplastic polymer in an amount of 10-99 wt. %, based on the total weight of the composition, and an expandable graphite component in an amount of up to 20 wt. %, based on the total weight of the composition. In some instances, the expandable graphite component comprises, consists of, or consists essentially of expandable graphite in its free form. Alternatively, in other cases, the expandable graphite is encapsulated in a different material, as described further hereinbelow. The thermoplastic polymer, in some embodiments, comprises an acrylonitrile butadiene styrene (ABS), a polylactic acid (PLA), a polyethylene terephthalate (PET), a thermoplastic polyurethane (TPU), a nylon, a polycarbonate, or a combination, block copolymer, or melt of two or more of the foregoing.

Methods of printing or forming a 3D article are also described herein. In some embodiments, such a method comprises providing a composition described herein and selectively solidifying layers of the composition to form the article. In some cases, the composition is provided in a layer-by-layer process. Moreover, in some instances, a composition and method described herein provide a printed article having flame resistant and/or fire retardant properties. For example, in some embodiments, an article formed from a composition and/or method described herein has a v0 or v1 rating according to UL 94 V.

In addition, an article formed from a composition and/or method described herein can provide flame resistance and/or fire retardation while also maintaining other desired mechanical properties and/or compositional microstructures. For example, in some instances, a completed article formed using compositions and/or methods described herein can have one, two, three, four, or five of the following compositional parameters (e.g., due to the composition and microstructure of the article): (i) an elongation at break (EOB) of at least 5% or between 5% and 10% (e.g., when determined according to ASTM D638); (ii) a tensile modulus (or Young's modulus) of at least 2000 MPa, at least 3000 MPa, or between 2000 MPa and 4000 MPa, when measured according to ASTM D638; (iii) a tensile strength of at least 25 MPa, at least 35 MPa or between 25 MPa and 50 MPa, when measured according to ASTM D638; (iv) a heat deflection temperature (HDT) of at least 50° C., at least 60° C., at least 70° C., or between 50° C. and 75° C. at a load of 1.82 MPa, when measured according to ASTM D648; (v) an HDT of at least 50° C., at least 60° C., at least 70° C., at least 80° C., at least 90° C., at least 100° C., or between 70° C. and 120° C. at a load of 0.455 MPa, when measured according to ASTM D648.

These and other embodiments are further described in the following detailed description.

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” should generally be considered to include the end points 5 and 10.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage could be 0.1, 1, 5, or 10 percent, unless the use of such a term in a given instance indicates otherwise.

It is also to be understood that the article “a” or “an” refers to “at least one,” unless the context of a particular use requires otherwise.

The terms “three-dimensional printing system,” “three-dimensional printer,” “printing,” and the like generally describe various solid freeform fabrication techniques for making three-dimensional articles or objects by selective laser sintering (SLS), stereolithography (SLA), dynamic light projection (DLP), selective deposition, jetting, fused deposition modeling (FDM), multijet modeling (MJM), and other additive manufacturing techniques now known in the art or that may be known in the future that use a build material or ink to fabricate three-dimensional objects.

In one aspect, compositions for use in additive manufacturing applications are described herein. The compositions, for example, can be employed in SLS and FDM printing applications.

A composition described herein, in some embodiments, comprises a sinterable powder in an amount of 10-99 wt. %, based on the total weight of the composition, and an expandable graphite component in an amount of up to 20 wt. %, based on the total weight of the composition. Other components may also be included in a composition described herein.

As described further herein, compositions according to the present disclosure can provide flame resistance and/or fire retardation while also maintaining other desired mechanical properties. More particularly, in some cases, compositions described herein can provide or impart intumescent properties to articles formed from the compositions. Fire generally requires three components to start: fuel, oxygen, and flame or ignition. Flame or fire retardant or resistant solutions, such as those described herein, can remove or inhibit one or more of the foregoing components of the so-called “fire triangle.” In some embodiments, a composition or printed 3D article described herein is intumescent. Such an intumescent composition or article can create a physical barrier (such as a char or non-flammable material) between a flame or fire and the flame's or fire's fuel (e.g., where the “fuel” would be a portion or all of the composition or article itself, which might otherwise burn or burn more quickly, were it not for the physical barrier provided by the intumescent composition).

Turning now to specific components, compositions described herein comprise an expandable graphite component (which may also be referred to in some cases as an exfoliated graphite component). Any expandable graphite component not inconsistent with the technical objectives of the present disclosure may be used. Moreover, as understood by one of ordinary skill in the art, an expandable graphite component can comprise or be formed from intercalated graphite sheets or flakes, wherein the intercalated graphite comprises an acidic intercalant or other intercalant, which intercalant may be molecular, atomic, or ionic. That is, in some implementations, an expandable graphite component described herein comprises graphite sheets (or a plurality of graphene layers) and one or more intercalants disposed between the graphite sheets (or the plurality of graphene layers). For example, in some cases, an expandable graphite component described herein comprises an intercalant comprising a molecular acid or an ionic form thereof.

In some instances, an expandable graphite component described herein is formed by treating natural flake graphite with one or more acids (such as HNO₃, H₂SO₄, H₃PO₄, HCIO₄, and/or CH₃COOH) or oxidizing agents (such as KMnO₄, KCIO₃, or H₂O₂). After treatment, the expandable graphite product can be washed with water to remove remaining acid and/or oxidizing reagent and then dried. Such treatment (or other treatments for providing expandable graphite) can produce graphite intercalation compounds (GICs). As understood by one of ordinary skill in the art, and not intending to be bound by theory, when a GIC is exposed to heat, the intercalated layers of graphite can further separate, causing the material to expand. Moreover, an expandable graphite component described herein, when heated, can form a protective char.

Further, in some embodiments, the surface chemistry of an expandable graphite component described herein, defined as the pH or pKa value at the flake surface of the expandable graphite component, can be modified to be acidic, basic, or neutral. In some instances, an expandable graphite component described herein has a pH or pKa value of 5-11, 5-9, 5-7, 7-9, 9-11, or 7-11.

Moreover, the expandable graphite component can have any expansion volume not inconsistent with the technical objectives of the present disclosure. For reference purposes herein, expansion volume is defined as the increase in volume a material will swell or expand when heated from room temperature to a given test temperature. That is, the expansion volume is the volume increase at the test temperature as compared to an initial temperature of room temperature (22° C.). For the expandable graphite component described herein, expansion volume can be assessed at 300° C., 500° C., 700° C., or 1000° C. For these test temperatures, the expandable graphite component described herein can exhibit an expansion volume of 80-400 cc/g, 100-400 cc/g, 150-400 cc/g, 200-400 cc/g, 100-300 cc/g, 200-300 cc/g, 300-400 cc/g, or 80-200 cc/g, where cc/g refers to cubic centimeter (or milliliter, mL) of expansion per gram of material. Other expansion volumes are also possible. Moreover, the expansion volume, in some cases, can be measured using thermomechanical analysis (TMA) or thermodilatometric analysis (TDA, which may also be referred to as zero force TMA).

Additionally, the expandable graphite component of a composition described herein can have a desirable onset temperature. For reference purposes herein, onset temperature is defined as the temperature at which the expanded graphite component begins to expand. In some embodiments, the expandable graphite component described herein has an onset temperature of 150-280° C., 150-190° C., 190-220° C., 220-250° C., 250-280° C., 150-220° C., 220-280° C., or 200-280° C. Other onset temperatures are also possible. Moreover, the onset temperature of an expandable graphite component described herein can be measured using TMA (e.g., zero force TMA in accordance with ASTM E831), where the onset temperature is assigned as the temperature at which volume expansion begins according to TMA.

In some embodiments, an expandable graphite component described herein can be used within the additive manufacturing composition as a free powder of the expandable graphite. In other embodiments, the expandable graphite component comprises expandable graphite encapsulated in a shell or encapsulating material. In some instances, the shell or encapsulating material can coat, surround, or contain the expandable graphite, such that the expandable graphite is completely (or substantially completely) disposed within the shell or capsule. For example, in some cases, the expandable graphite is at least 90%, at least 95%, at least 98%, or at least 99% contained or encapsulated within the shell or encapsulating material. The expandable graphite component of a composition described herein, in some embodiments, can thus be a core-shell component, wherein the core comprises or is formed from the expandable graphite itself, and the shell is formed from the encapsulating material.

Any shell or encapsulating material not inconsistent with the technical objectives of the present disclosure may be used. In some embodiments, for example, the shell or encapsulating material comprises or consists of another component of an additive manufacturing composition described herein. For example, in some cases, the shell or encapsulating material comprises or is formed from a material of a sinterable powder described herein, such as a semicrystalline polymer described hereinbelow or a filler material described hereinbelow. In other instances, the shell or encapsulating material comprises or is formed from a thermoplastic polymer described hereinbelow.

Moreover, in some cases, the shell or encapsulating material has a melting point that differs from the melting point or onset temperature of the expandable graphite that is encapsulated within the shell or encapsulating material. For instance, in some preferred embodiments, the encapsulating material has a melting point that is at least 30° C. lower or at least 20° C. lower than the onset temperature of the expandable graphite it encapsulates. In some cases, the encapsulating material has a melting point that is 20-60° C., 20-50° C., 20-40° C., 30-60° C., 30-50° C., or 30-40° C. lower than the onset temperature of the expandable graphite it encapsulates.

Further, when the expandable graphite component comprises a core-shell structure such as described above, the ratio of expandable graphite to shell material is not necessarily limited. In some embodiments, a core-shell expandable graphite component comprises at least 5 wt. %, at least 10 wt. %, at least 20 wt. %, or at least 30 wt. % shell material, based on the total weight of the expandable graphite component. In some cases, a core-shell expandable graphite component comprises 5-90 wt. %, 5-80 wt. %, 5-70 wt. %, 5-60 wt. %, 5-50 wt. %, 5-40 wt. %, 5-30 wt. %, 5-25 wt. %, 5-20 wt. %, 5-10 wt. %, 10-90 wt. %, 10-80 wt. %, 10-70 wt. %, 10-60 wt. %, 10-50 wt. %, 10-40 wt. %, 10-30 wt. %, 10-25 wt. %, 10-20 wt. %, 20-90 wt. %, 20-80 wt. %, 20-70 wt. %, 20-60 wt. %, 20-50 wt. %, 20-40 wt. %, 20-30 wt. %, 30-90 wt. %, 30-80 wt. %, 30-70 wt. %, 30-60 wt. %, 30-50 wt. %, or 30-40 wt. % shell material, based on the total weight of the expandable graphite component, with the balance being the expandable graphite.

Additionally, the expandable graphite component of a composition described herein can have one or more properties advantageous for use in additive manufacturing (in addition to having intumescent properties as described above). For example, in some embodiments, the expandable graphite component is a particulate material (whether core-shell or otherwise) and has an average particle size in three dimensions (e.g., a D50 value) of 50-350 μm, 75-350 μm, 100-350 μm, 125-350 μm, 75-325 μm, 75-275 μm, 75-225 μm, 80-200 μm, 150-200 μm, or 150-350 μm. In some preferred embodiments, for instance, a core-shell expandable graphite component described herein has an average particle size (e.g., D50) of 50-200 μm, 50-175 μm, 50-150 μm, 50-125 μm, 50-100 μm, 50-80 μm, 80-200 μm, 80-175 μm, 80-150 μm, 80-125 μm, 80-100 μm, 100-125 μm, 100-150 μm, 100-175 μm, 100-200 μm, 125-200 μm, 125-150 μm, 125-175 μm, 125-200 μm, 150-175 μm, 150-200 μm, or 175-200 μm. Particle sizes described herein can be measured using any suitable method known to one of ordinary skill in the art. For example, in some preferred embodiments, particle size is determined using sieve analysis, including in accordance with ASTM D1921. Further, a particulate expandable graphite component described herein, in some implementations, has a monomodal particle size distribution (PSD), as opposed to a bimodal or other higher order PSD.

Moreover, in some cases, the particle size of a particulate expandable graphite component is selected with reference to (or in combination with) the size of another particulate material of a composition described herein and/or with respect to a printing parameter. For example, in some embodiments, a sinterable powder of a composition described herein has an average particle size in three dimensions (e.g., a D50 determined in accordance with ASTM D1921), and the expandable graphite component is a particulate material having an average particle size in three dimensions (e.g., a D50 value determined in accordance with ASTM D1921). Additionally, in some such instances, the average particle size of the expandable graphite component is larger than the average particle size of the sinterable powder. For example, in some such cases, the average particle size of the sinterable powder is 60-300 μm, and the average particle size of the expandable graphite component is 80-350 μm. In other such embodiments (in which the expandable graphite component has a larger average size than the sinterable powder), the average particle size of the sinterable powder is 60-150 μm, and the average particle size of the expandable graphite component is 80-200 μm. Not intending to be bound by theory, it is believed that such a combination of particle sizes can unexpectedly permit formation of fire or flame resistant articles through an additive manufacturing process, where the formed articles have high resolution and fire/flame resistant properties, without suffering from printing defects typically caused by the presence of relatively large additive particles such as the expandable graphite component particles described above.

Additionally, in some cases, a particulate expandable graphite component (such as an expandable graphite component having a core-shell structure described above), has high roundness, sphericity, and/or flowability. For example, in some embodiments, a particulate expandable graphite component (such as a core-shell expandable graphite component) has an average aspect ratio (the average ratio of largest length or dimension of a particle compared to the smallest length or dimension of the particle) of 0.8 to 1.2. For example, in some cases, a particulate expandable graphite component (e.g., a core-shell expandable graphite component) may have an average aspect ratio of 0.9-1.1. The aspect ratio of a particle can be measured or determined in any manner known to one of ordinary skill in the art. In some preferred embodiments, for instance, the average aspect ratio of a population of expandable graphite component particles is determined using dynamic image analysis in accordance with ISO 13322-2:2021.

Similarly, in some implementations, a particulate expandable graphite component (e.g., an expandable graphite component having a core-shell structure) has a Hausner ratio of 1.0 to 1.2. In some instances, a particulate expandable graphite component has a Hausner ratio of less than 1.1, such as between 1.0 and 1.1. As understood by one of ordinary skill in the art, the Hausner ratio is the ratio of tap (or tapped or tamped) density (measured according to ASTM B527) to apparent density (measured according to ASTM D1895B).

Further, a particulate expandable graphite component described herein (such as an expandable graphite component having a core-shell structure described above) can have a combination of two or more of the features described above, such as an average particle size described above, an average aspect ratio described above, and a Hausner ratio described above.

An expandable graphite component described herein can be present in any amount not inconsistent with the technical objectives of the present disclosure. In some cases, for example, the expandable graphite component is present in an amount of up to 20 wt. %, up to 15 wt. %, up to 10 wt. %, or up to 5 wt. %, based on the total weight the composition. In some instances, the expandable graphite component is present in an amount of 1-20 wt. %, 1-15 wt. %, 1-10 wt. %, 1-5 wt. %, 5-20 wt. %, 5-15 wt. %, 10-15 wt. %, or 10-20 wt. %, based on the total weight of the composition. In some cases, the expandable graphite component is present in an amount of no more than 20 wt. %, based on the total weight of the composition.

Turning to other possible additional components, in some cases a composition described herein further comprises a blowing agent component. Any blowing agent component not inconsistent with the technical objectives of the present disclosure may be used. For example, in some cases, the blowing agent component comprises urea, a urea-formaldehyde resin, or dicyandiamide.

A blowing agent component described herein can be present in any amount not inconsistent with the technical objectives of the present disclosure. In some cases, for example, the blowing agent component is present in an amount of up to 5 wt. %, up to 3 wt. %, up to 1 wt. %, up to 0.5 wt. %, or up to 0.1 wt. %, based on the total weight the composition. In some instances, the blowing agent component is present in an amount of 0.1-5 wt. %, 0.1-3 wt. %, 0.1-1 wt. %, 0.5-5 wt. %, 0.5-3 wt. %, or 0.5-1 wt. %, based on the total weight of the composition. In some embodiments, a composition described herein does not comprise a blowing agent component, or comprises less than 0.1 wt. % blowing agent component.

Compositions described herein, in some embodiments, also comprise a sinterable powder. As understood by a person of ordinary skill in the art, a “sinterable” powder can be selectively sintered or fused by application of energy, such as provided by a laser beam or other source of electromagnetic radiation. The application of energy (e.g., a selectively applied laser beam) can selectively heat powder particles, with the result that the powder partially melts and adjacent particles fuse with one another. “Sintering” can thus in some cases include the heating of the powder to a temperature which causes viscous flow only at contiguous boundaries of the individual powder particles, with at least some portion of substantially all particles remaining solid. As described above, such sintering can cause coalescence of particles into a sintered solid mass, the bulk density of which is increased compared to the bulk density of the powder particles before they were sintered. Such fusing can provide a solidified portion (e.g., a cross-section or layer) of an article or object being printed or formed by the process. An article or object formed by layer-by-layer or “slice-wise” joining of vertically contiguous layers which are sintered into stacked “layers” or “slices” can thus be described as autogenously densified. Such slices or layers can have a thickness of, for example, up to about 250 μm, such as in the range of 50 μm to 180 μm.

A sinterable powder of the present disclosure can thus have optical properties, thermal properties, and other properties suitable for use with a 3D printing system or method that forms objects by fusing or sintering individual powder particles together in a selective way. For instance, a sinterable powder can have optical (e.g., absorbance) and/or thermal properties (e.g., glass transition temperature, Tg; melting point, MP; or crystallization temperature Tc) selected for sintering with a particular source of electromagnetic radiation. In some embodiments, a sinterable powder described herein has a non-zero absorbance or an absorbance peak at the wavelength used in the 3D printing process (e.g., at the peak wavelength of the laser, such as a CO₂ laser, used in an SLS process). Moreover, in some cases, a sinterable powder described herein has a sintering window (defined as the metastable thermodynamic region between melting and crystallization, or the difference between the MP onset and Tc onset) of at least 10° C., such as a sintering window of 10-30° C., 10-25° C., or 10-20° C., when measured by differential scanning calorimetry (DSC) using a heating rate of 10° C./min. Additionally, in some instances, a sinterable powder described herein has an MP of 120-270° C., 150-250° C., 150-200° C., 150-180° C., 170-250° C., 170-220° C., 170-200° C., 190-250° C., 190-220° C., or 200-250° C.

Additionally, in some cases, a sinterable powder can have an average particle size and a flowability suitable for use in such an additive manufacturing method. For example, in some embodiments, a sinterable powder described herein has an average particle size (D50) of 60-300 μm, 60-250 μm, 60-200 μm, 60-150 μm, 60-100 μm, 80-300 μm, 80-250 μm, 80-200 μm, 80-150 μm, 80-100 μm, 100-300 μm, 100-250 μm, 100-200 μm, 150-300 μm, 150-250 μm, 150-200 μm, 200-300 μm, or 200-250 μm. A sinterable powder described herein, in some implementations, has a monomodal particle size distribution (PSD), as opposed to a bimodal or other higher order PSD. Average particle size and particle size distribution can be measured in accordance with ASTM D1921.

Further, in some cases, a sinterable powder described herein has a normalized packing density of 20-45% or 25-40%. Moreover, in some embodiments, a sinterable powder described herein has an average roundness (defined as the ratio between the measured area of a particle and the area of an equivalent circle with the maximum length of the particle as diameter) of 0.4 to 0.6. Average roundness can be measured using dynamic image analysis. Moreover, in some embodiments, a sinterable powder described herein has a bulk density and/or a tap (or tapped or tamped) density above 0.35 g/mL or above 0.4 g/mL, such as a bulk and/or tap (or tapped or tamped) density between 0.35 and 1 g/mL or between 0.4 and 1 g/mL, when measured in accordance with ASTM D1895B (bulk density) or ASTM B527 (tap density).

It is further to be noted that, in some cases, an expandable graphite component described herein does not significantly alter the sintering window of a sinterable powder described herein. For example, in some cases, the sintering window of a composition including an expandable graphite component described herein has a width (in degrees Celsius) and/or one or more end points (in degrees Celsius) that is within 1° C., within 2° C., or within 5° C. of an otherwise similar composition that does not include the expandable graphite component. Moreover, in some instances, a composition described herein that comprises the expandable graphite component does not smoke or generate smoke when heated by a laser or other source of heat in an additive manufacturing process, such as described herein. Thus, in some embodiments, carrying out a method described herein does not generate smoke observable to a human observer having average visual acuity when observing the method without any instruments or visual aids other than corrective lenses such as glasses or contact lenses.

Any sinterable powder not inconsistent with the objectives of the present disclosure may be used. In some cases, the sinterable powder comprises a semicrystalline polymer, including in some instances as a primary or majority component (by mass or weight) of the sinterable powder. Any semicrystalline polymer not inconsistent with the objectives of the present disclosure may be used. In some implementations, the sinterable powder of a composition described herein comprises (or primarily comprises as the majority component) a polyamide (PA), a polyester (PEs), a polyurethane (PU), a polyethyelene (PE), a polypropylene (PP), a poly(butylene terephthalate) (PBT), a poly(etheretherketone) (PEEK), a poly(etherketoneketone) (PEKK), or a combination of two or more of the foregoing. When the sinterable powder comprises a polyamide (PA), any PA not inconsistent with the objectives of the present disclosure may be used. For example, in some cases, the PA comprises polyamide-11 (PA 11), polyamide-12 (PA 12), or a combination of PA 11 and PA 12.

In some instances, the PA comprises a polyamide comprising or formed from one or more lactams, such as the combination of laurolactam and caprolactam. In some such embodiments, the proportion of caprolactam is 40-60 mol. % of the total lactams used. Moreover, in some embodiments, a polyamide comprising or formed from laurolactam and caprolactam as described above may form all or part of a sinterable powder of a composition described herein. For example, in some cases, such a polyamide is the primary or majority component of a sinterable powder composition. For instance, in some embodiments, the polyamide powder formed from laurolactam and caprolactam forms up to 100 wt. %, up to 99 wt. %, up to 95 wt. %, or up to 90 wt. % of the sinterable powder, based on the total weight of the sinterable powder. In some instances, the sinterable powder comprises 50-100 wt. %, 50-99 wt. %, 50-90 wt. %, 50-80 wt. %, 50-70 wt. %, 60-100 wt. %, 60-99 wt. %, 60-90 wt. %, 70-100 wt. %, 70-99 wt. %, 70-90 wt. %, 80-100 wt. %, 80-99 wt. %, 80-95 wt. %, 85-100 wt. %, 85-99 wt. %, 85-95 wt. %, 90-100 wt. %, or 90-99 wt. % polyamide powder described above, based on the total weight of the sinterable powder.

Additionally, in some embodiments, a polyamide comprising or formed from laurolactam and caprolactam (as described above) has a relative viscosity in the range of 1.4-1.8 in m-cresol at 20° C. and at 0.5 wt. % when determined according to ISO 307. For example, the relative viscosity can be 1.4-1.5, 1.5-1.6, 1.6-1.7, or 1.7-1.8 in m-cresol at 20° C. and at 0.5 wt. % according to ISO 307.

Moreover, in some cases, a polyamide comprising or formed from laurolactam and caprolactam as described herein has a melting point in the range of 110-190° C. when determined according to ASTM D3418. For example, such a polyamide, in some cases, can have a melting point of 110-120° C., 120-130° C., 130-140° C., 150-160° C., 170-180° C., or 180-190° C. when determined according to ASTM D3418.

Additionally, in other embodiments, a polyamide comprising or formed from laurolactam and caprolactam described herein has a crystallization temperature in the range of 90-160° C. when determined according to ASTM D3418. For example, in some cases, the polyamide comprising or formed from laurolactam and caprolactam can have a crystallization temperature of 90-100° C., 100-110° C., 110-120° C., 120-130° C., 130-140° C., or 150-160° C. when determined according to ASTM D3418.

Turning again more generally to the sinterable powder of a composition described herein, a sinterable powder described herein, in some cases, comprises up to 100 wt. %, up to 99 wt. %, up to 95 wt. %, or up to 90 wt. % semicrystalline polymer, based on the total weight of the sinterable powder (not based on the total weight of the overall composition). In some instances, the sinterable powder comprises 50-100 wt. %, 50-99 wt. %, 50-90 wt. %, 50-80 wt. %, 50-70 wt. %, 60-100 wt. %, 60-99 wt. %, 60-90 wt. %, 70-100 wt. %, 70-99 wt. %, 70-90 wt. %, 80-100 wt. %, 80-99 wt. %, 80-95 wt. %, 85-100 wt. %, 85-99 wt. %, 85-95 wt. %, 90-100 wt. %, or 90-99 wt. % semicrystalline polymer, based on the total weight of the sinterable powder.

In addition to a primary or majority component such as described above, a sinterable powder described herein can also comprise one or more additional components. In some embodiments, for instance, the sinterable powder comprises a filler material. Any filler material not inconsistent with the objectives of the present disclosure may be used. For example, in some cases, the filler material comprises glass, ceramic, or carbon fiber. In some embodiments, the filler material is in the form of spheres, plates, or fibers, and the shape of any filler material is not particularly limited.

A filler material, if used, can be present in the sinterable powder in any amount not inconsistent with the technical objectives of the present disclosure. For example, in some cases, a sinterable powder described herein comprises up to 30 wt. %, up to 20 wt. %, up to 15 wt. %, or up to 10 wt. % filler material, based on the total weight of the sinterable powder (not based on the total weight of the overall composition). In some instances, the sinterable powder comprises 1-30 wt. %, 1-25 wt. %, 1-20 wt. %, 1-15 wt. %, 1-10 wt. %, 1-5 wt. %, 5-30 wt. %, 5-25 wt. %, 5-20 wt. %, 5-15 wt. %, or 5-10 wt. % filler material, based on the total weight of the sinterable powder.

A sinterable powder described herein may also comprise a flowing agent. Any flowing agent not inconsistent with the technical objectives of the present disclosure may be used. For example, in some cases, a flowing agent comprises a nanoparticulate coating or other coating on the sinterable powder or on a semicrystalline polymer of the sinterable powder, such as a silica nanoparticle coating. One example of a flowing agent suitable for use in some embodiments described herein is Aerosil 200.

A flowing agent, if used, can be present in the sinterable powder in any amount not inconsistent with the technical objectives of the present disclosure. For example, in some cases, a sinterable powder described herein comprises up to 10 wt. %, up to 5 wt. %, up to 1 wt. %, or up to 0.5 wt. % flowing agent, based on the total weight of the sinterable powder (not based on the total weight of the overall composition). In some instances, the sinterable powder comprises 0.01-10 wt. %, 0.01-5 wt. %, or 0.01-1 wt. % flowing agent, based on the total weight of the sinterable powder.

Additionally, in some cases, a composition described herein excludes or contains very small amounts of certain components. For instance, in some cases, a composition described herein is free or substantially free of phosphate. A composition described herein that is “substantially free of” phosphate can, in some embodiments, comprise or include less than 5 wt. %, less than 3 wt. %, less than 1 wt. %, or less than 0.5 wt. % phosphate, based on the total weight of the composition. In some cases, a composition that is substantially free of phosphate comprises less than 0.1 wt. % or less than 0.01 wt. % phosphate, based on the total weight of the composition.

In addition to compositions for additive manufacturing, methods of additive manufacturing are also described herein. Such methods of forming or printing a 3D article, object, or part can include forming the 3D article from a plurality of layers of composition described herein, as a build material, including in a layer-by-layer manner. Any composition described hereinabove may be used. Further, the layers of a composition can be formed or provided according to an image of the 3D article in a computer readable format, such as according to preselected computer aided design (CAD) parameters.

As stated previously, such methods can include SLS or other sintering methods. An SLS method, as understood by one of ordinary skill in the art, can comprise retaining a composition described herein in a container (such as a build bed or powder bed) and selectively applying energy to the composition in the container to solidify (or consolidate or sinter) at least a portion of a layer of the composition, thereby forming a solidified (or consolidated or sintered) layer that defines a cross-section of the 3D article. Additionally, a method described herein can further comprise raising or lowering the solidified layer of the composition to provide a new or second layer of unsolidified composition at the surface of the composition in the container, followed by again selectively applying energy to the composition in the container to solidify (or consolidate or sinter) at least a portion of the new or second layer of the composition to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying (or consolidating or sintering) the composition. Moreover, selectively applying energy to the composition in the container can comprise applying electromagnetic radiation having a sufficient energy to solidify (or consolidate or sinter) the composition. In some instances, the electromagnetic radiation has an average wavelength of 300-1500 nm. In some cases, the solidifying (or consolidating or sintering) radiation is provided by a computer controlled laser beam. In addition, in some cases, raising or lowering a solidified layer of composition is carried out using an elevator platform disposed in the container. A method described herein can also comprise planarizing a new layer of the composition provided by raising or lowering an elevator platform, or rolling out a new layer of the composition. Such planarization or rolling can be carried out, in some cases, by a wiper or roller.

It is further to be understood that the foregoing process can be repeated a desired number of times to provide the 3D article. For example, in some cases, this process can be repeated “n” number of times, wherein n can be up to about 100,000, up to about 50,000, up to about 10,000, up to about 5000, up to about 1000, or up to about 500. Thus, in some embodiments, a method of printing a 3D article described herein can comprise selectively applying energy to a composition in a container to solidify (or consolidate or sinter) at least a portion of an nth layer of the composition, thereby forming an nth solidified layer that defines an nth cross-section of the 3D article, raising or lowering the nth solidified layer of the composition to provide an (n+1)th layer of unsolidified composition at the surface of the composition in the container, selectively applying energy to the (n+1)th layer of the composition in the container to solidify at least a portion of the (n+1)th layer of the composition to form an (n+1)th solidified layer that defines an (n+1)th cross-section of the 3D article, raising or lowering the (n+1)th solidified layer of the composition to provide an (n+2)th layer of unsolidified composition at the surface of the composition in the container, and continuing to repeat the foregoing steps to form the 3D article. Further, it is to be understood that one or more steps of a method described herein, such as a step of selectively applying energy to a layer of composition, can be carried out according to an image of the 3D article in a computer-readable format.

Thus, in some embodiments, a method of printing a 3D article described herein comprises providing a composition described hereinabove and selectively solidifying layers of the composition to form the article. Moreover, in some cases, the composition is provided in a layer-by-layer process. In some cases, the method is an SLS or other particle sintering method of additive manufacturing.

Compositions and methods described herein are not necessarily limited to selective laser sintering (SLS) or other sintering applications or uses. The present disclosure also contemplates compositions and methods of forming articles using other additive manufacturing techniques. For example, in some instances, compositions and methods for fused deposition modeling (FDM) are also described. In such embodiments, the sinterable powder described above can be replaced with a different material, such as a thermoplastic polymer that can be extruded, jetted, or otherwise deposited in a layer-by-layer manner to form a 3D article (e.g., extruded from pellets or filaments).

Therefore, in some cases, a composition for additive manufacturing is described herein, wherein the composition comprises a thermoplastic polymer in an amount of 10-99 wt. %, based on the total weight of the composition, and an expandable graphite component in an amount of up to 20 wt. %, based on the total weight of the composition.

In such embodiments, it is to be understood that the expandable graphite component can be the same or have the same characteristics as described above for compositions comprising a sinterable powder instead of a thermoplastic polymer. Other additives or components described above (such as a blowing agent) may also be the same or have the same characteristics as described above for compositions comprising a sinterable powder instead of a thermoplastic polymer.

Additionally, the thermoplastic polymer of the composition can comprise any thermoplastic polymer not inconsistent with the technical objectives of the present disclosure. For example, in some cases, the thermoplastic polymer comprises an acrylonitrile butadiene styrene (ABS), a polylactic acid (PLA), a polyethylene terephthalate (PET), a thermoplastic polyurethane (TPU), a nylon, a polycarbonate, or a combination, block copolymer, or melt of two or more of the foregoing.

Such a composition as described above can be used in material deposition methods of additive manufacturing, such as FDM. In a material deposition method, one or more layers of a composition described herein are selectively deposited onto a substrate as a build material and solidified. Solidifying, in some cases, comprises rapid cooling of the composition or the composition's undergoing of a phase transition (e.g., from liquid to solid).

Thus, in some instances, a composition (or build material) described herein is selectively deposited in a fluid state onto a substrate, such as a build pad of a 3D printing system. Selective deposition may include, for example, depositing the build material according to preselected CAD parameters. For example, in some embodiments, a CAD file drawing corresponding to a desired 3D article to be printed is generated and sliced into a sufficient number of horizontal slices. Then, the build material is selectively deposited, layer by layer, according to the horizontal slices of the CAD file drawing to print the desired 3D article. A “sufficient” number of horizontal slices is the number necessary for successful printing of the desired 3D article, e.g., to produce it accurately and precisely.

Further, in some embodiments, a preselected amount of build material described herein is heated to the appropriate temperature and extruded or expelled from a nozzle or print head or a plurality of nozzles or print heads of a suitable printer to form a layer on a print pad in a print chamber. In some cases, each layer of build material is deposited according to preselected CAD parameters. As stated above, in some embodiments, a composition (or build material) described herein exhibits a phase change upon deposition and/or solidifies upon deposition. Moreover, in some cases, the temperature of the printing environment can be controlled so that the deposited portions of build material solidify on contact with the receiving surface. Additionally, in some instances, after each layer is deposited, the deposited material is planarized prior to the deposition of the next layer. Optionally, several layers can be deposited before planarization. Planarization corrects the thickness of one or more layers by evening the dispensed material to remove excess material and create a uniformly smooth exposed or flat up-facing surface on the support platform of the printer. In some embodiments, planarization is accomplished with a wiper device, such as a roller, which may be counter-rotating in one or more printing directions but not counter-rotating in one or more other printing directions. In some cases, the wiper device comprises a roller and a wiper that removes excess material from the roller. Further, in some instances, the wiper device is heated. It should be noted that the consistency of the deposited build material described herein, in some embodiments, should desirably be sufficient to retain its shape and not be subject to excessive viscous drag from the planarizer. Layered deposition of the build material can be repeated until the 3D article has been formed.

As stated above, in some embodiments of compositions and methods described herein, a particulate expandable graphite component is used. In some such embodiments, the average particle size of the particulate expandable graphite component (e.g., the D50 of the expandable graphite component) is selected based on an additive manufacturing or printing parameter. For example, in some instances, the expandable graphite component is a particulate component having an average particle size in three dimensions (e.g., D50) that is greater than an average thickness of the solidified layers formed by the additive manufacturing method in which the composition is used (e.g., SLS, FDM, or another method of additive manufacturing). As stated above, it is to be understood that the “thickness” of the solidified layers is along the z-direction (as opposed to being along an x-direction or y-direction of a solidified layer or stack of solidified layers). In some such implementations, the expandable graphite component has an average particle size in three dimensions of 80-200 μm, and the solidified layers have an average thickness of 50 μm to 180 μm.

Compositions and methods (e.g., SLS or FDM methods) described herein can form 3D articles that exhibit flame or fire resistant or retardant properties. For example, in some cases, the article has a v0 or v1 rating according to UL 94 V. Testing sample thickness achieving a v0 or v1 rating can be less than 2 mm or less than 1 mm, such as 0.8 mm or 0.4 mm, in some embodiments.

Moreover, compositions and methods described herein can be used to provide 3D articles that also have desirable mechanical properties, in addition to exhibiting flame or fire resistant or retardant properties. In some embodiments, a 3D article formed using compositions and/or methods describe herein has an elongation at break greater than 5 percent when determined in accordance with ASTM D638. For example, the article can have an EOB of 5-10%. Similarly, a 3D article described herein can have a tensile modulus of 2000-4000 MPa, when determined in accordance with ASTM D638. In some embodiments, the article can exhibit a tensile modulus of 2000-2500 MPa, 2500-3000 MPa, 3000-3500 MPa, or 3500-4000 MPa when tested in accordance with ASTM D638. Moreover, in some implementations, a 3D article formed using compositions and/or methods described herein can exhibit a tensile strength of 25 to 50 MPa, when determined in accordance with ASTM D638. In some embodiments, the article exhibits a tensile strength of 30 to 45 MPa tested in accordance with ASTM D638. Additionally, in some cases, a 3D article formed using a composition and/or method described herein has a heat deflection temperature (HDT) of 50-80° C. at 1.82 MPa when determined according to ASTM D648, and/or an HDT 100-120° C. at 0.455 MPa when determined according to ASTM D648.

These foregoing embodiments are further illustrated in the following non-limiting examples.

### Examples

Table 1 provides properties of compositions according to some embodiments described herein. For each of Examples 1-8, the composition included approximately 80 wt. % sinterable powder (polyamide formed from laurolactam and caprolactam) and approximately 20 wt. % expandable graphite component, as well as approximately 0.1 wt. % flowing agent (Aerosil 200). Elongation at break, tensile modulus, and tensile strength were measured in accordance with ASTM D638. Heat deflection temperature (HDT) was measured using both 1.82 MPa and 0.455 MPa according to ASTM D648.

TABLE 1
Article Properties

| | Elongation | Tensile | Tensile | HDT | HDT |
|---|---|---|---|---|---|
| | at Break | Strength | Modulus | (0.455 | (1.820 |
| | (%) | (MPa) | (MPa) | MPa) | MPa) |
| Example 1 | 8.8 | 30 | 2306 | 111 | 51 |
| Example 2 | 8.9 | 31 | 2519 | 108 | 64 |
| Example 3 | 8.8 | 31 | 2663 | 113 | 54 |
| Example 4 | 10.1 | 32 | 2504 | 106 | 71 |
| Example 5 | 8.9 | 34 | 2525 | 108 | 73 |
| Example 6 | 9.2 | 37 | 2953 | 114 | 70 |
| Example 7 | 9.8 | 40 | 3315 | 110 | 75 |
| Example 8 | 9.8 | 44 | 3742 | 111 | 66 |

Some additional non-limiting example embodiments are described below.
Embodiment 1. A composition for additive manufacturing comprising:
a sinterable powder in an amount of 10-99 wt. %, based on the total weight of the composition; and
an expandable graphite component in an amount of up to 20 wt. %, based on the total weight of the composition.
Embodiment 2. The composition of Embodiment 1, wherein the expandable graphite component is a particulate material having an average particle size in three dimensions of 50-350 μm.
Embodiment 3. The composition of Embodiment 1, wherein the expandable graphite component is a particulate material having an average particle size in three dimensions of 80-200 μm.
Embodiment 4. The composition of Embodiment 1, Embodiment 2, or Embodiment 3, wherein:
the sinterable powder has an average particle size in three dimensions; the expandable graphite component is a particulate material having an average particle size in three dimensions; and
the average particle size of the expandable graphite component is larger than the average particle size of the sinterable powder.
Embodiment 5. The composition of Embodiment 4, wherein:
the average particle size of the sinterable powder is 60-300 μm; and
the average particle size of the expandable graphite component is 80-350 μm.
Embodiment 6. The composition of Embodiment 4, wherein:
the average particle size of the sinterable powder is 60-150 μm; and
the average particle size of the expandable graphite component is 80-200 μm.
Embodiment 7. The composition of any of the preceding Embodiments, wherein the expandable graphite component is a particulate material having a Hausner ratio of 1.0 to 1.2.
Embodiment 8. The composition of any of the preceding Embodiments, wherein:
the sinterable powder comprises a semicrystalline polymer; and
the expandable graphite component comprises expandable graphite encapsulated in the semicrystalline polymer of the sinterable powder.
Embodiment 9. The composition of Embodiment 8, wherein the semicrystalline polymer of the sinterable powder has a melting point that is 20-60° C. lower than the onset temperature of the expandable graphite.
Embodiment 10. The composition of any of the preceding Embodiments, wherein the sinterable powder comprises a polyamide (PA), a polyester (PEs), a polyurethane (PU), a polyethyelene (PE), a polypropylene (PP), a poly(butylene terephthalate) (PBT), a poly(etheretherketone) (PEEK), a poly(etherketoneketone) (PEKK), or a combination of two or more of the foregoing.
Embodiment 11. The composition of Embodiment 10, wherein the sinterable powder comprises a polyamide.
Embodiment 12. The composition of Embodiment 10, wherein the polyamide is formed from laurolactam and caprolactam.
Embodiment 13. The composition of Embodiment 12, wherein the proportion of caprolactam is 40-60 mol. % of the total lactams used.
Embodiment 14. The composition of Embodiment 8, wherein:
the sinterable powder has an average particle size in three dimensions;
the expandable graphite component is a particulate material having an average particle size in three dimensions;
the average particle size of the expandable graphite component is larger than the average particle size of the sinterable powder; and
the expandable graphite component has a Hausner ratio of 1.0 to 1.2.
Embodiment 15. The composition of Embodiment 14, wherein the sinterable powder comprises a polyamide formed from laurolactam and caprolactam.
Embodiment 16. The composition of Embodiment 15, wherein the proportion of caprolactam is 40-60 mol. % of the total lactams used.
Embodiment 17. The composition of any of the preceding Embodiments, wherein the sinterable powder comprises a filler material.
Embodiment 18. The composition of any of the preceding Embodiments, wherein the composition is free or substantially free of phosphate.
Embodiment 19. A method of printing a three-dimensional article comprising:
providing the composition of any of Embodiments 1-18 (such as a composition comprising a sinterable powder in an amount of 10-99 wt. %, based on the total weight of the composition, and an expandable graphite component in an amount of up to 20 wt. %, based on the total weight of the composition); and
selectively solidifying layers of the composition to form the article.
Embodiment 20. The method of Embodiment 19, wherein the composition is provided in a layer-by-layer process.
Embodiment 21. The method of Embodiment 19 or Embodiment 20, wherein the expandable graphite component is a particulate component having an average particle size in three dimensions that is greater than an average thickness of the solidified layers.
Embodiment 22. The method of Embodiment 21, wherein:
the expandable graphite component has an average particle size in three dimensions of 80-200 μm; and
the solidified layers have an average thickness of 50 μm to 180 μm.
Embodiment 23. The method of any of Embodiments 19-22, wherein the article has a v0 rating according to UL 94V.
Embodiment 24. The method of any of Embodiments 19-22, wherein the article has a v1 rating according to UL 94V.
Embodiment 25. A composition for additive manufacturing comprising:
a thermoplastic polymer in an amount of 10-99 wt. %, based on the total weight of the composition; and
an expandable graphite component in an amount of up to 20 wt. %, based on the total weight of the composition.
Embodiment 26. The composition of Embodiment 25, wherein the expandable graphite component is a particulate material having an average particle size in three dimensions of 50-350 μm.
Embodiment 27. The composition of Embodiment 25, wherein the expandable graphite component is a particulate material having an average particle size in three dimensions of 80-200 μm.
Embodiment 28. The composition of any of Embodiments 25-27, wherein the expandable graphite component is a particulate material having a Hausner ratio of 1.0 to 1.2.
Embodiment 29. The composition of any of Embodiments 25-27, wherein the expandable graphite component comprises expandable graphite encapsulated in the thermoplastic polymer.
Embodiment 30. The composition of Embodiment 29, wherein the thermoplastic polymer has a melting point that is 20-60° C. lower than the onset temperature of the expandable graphite.
Embodiment 31. The composition of any of Embodiments 25-30, wherein the composition is free or substantially free of phosphate.
Embodiment 32. The composition of any of Embodiments 25-31, wherein the thermoplastic polymer comprises an acrylonitrile butadiene styrene (ABS), a polylactic acid (PLA), a polyethylene terephthalate (PET), a thermoplastic polyurethane (TPU), a nylon, a polycarbonate, or a combination, block copolymer, or melt of two or more of the foregoing.
Embodiment 33. A method of printing a three-dimensional article comprising:
providing the composition of any of Embodiments 25-32 (such as a composition comprising a thermoplastic polymer in an amount of 10-99 wt. %, based on the total weight of the composition, and an expandable graphite component in an amount of up to 20 wt. %, based on the total weight of the composition); and
selectively solidifying layers of the composition to form the article.
Embodiment 34. The method of Embodiment 33, wherein the composition is provided in a layer-by-layer process.
Embodiment 35. The method of Embodiment 33 or Embodiment 34, wherein the article has a v0 rating according to UL 94V.
Embodiment 36. The method of Embodiment 33 or Embodiment 34, wherein the article has a v1 rating according to UL 94V.
Embodiment 37. A printed 3D article formed using any of the compositions and/or methods of Embodiments 1-36.

All patent documents referred to herein are incorporated by reference in their entireties. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A composition for additive manufacturing comprising:
a sinterable powder in an amount of 10-99 wt. %, based on the total weight of the composition; and
an expandable graphite component in an amount of up to 20 wt. %, based on the total weight of the composition.

2. The composition of claim 1, wherein the expandable graphite component is a particulate material having an average particle size in three dimensions of 50-350 μm.

3. The composition of claim 1, wherein the expandable graphite component is a particulate material having an average particle size in three dimensions of 80-200 μm.

4. The composition of claim 1, wherein:
the sinterable powder has an average particle size in three dimensions;
the expandable graphite component is a particulate material having an average particle size in three dimensions; and
the average particle size of the expandable graphite component is larger than the average particle size of the sinterable powder.

5. The composition of claim 4, wherein:
the average particle size of the sinterable powder is 60-300 μm; and
the average particle size of the expandable graphite component is 80-350 μm.

6. The composition of claim 4, wherein:
the average particle size of the sinterable powder is 60-150 μm; and
the average particle size of the expandable graphite component is 80-200 μm.

7. The composition of claim 1, wherein the expandable graphite component is a particulate material having a Hausner ratio of 1.0 to 1.2.

8. The composition of claim 1, wherein:
the sinterable powder comprises a semicrystalline polymer; and
the expandable graphite component comprises expandable graphite encapsulated in the semicrystalline polymer of the sinterable powder.

9. The composition of claim 8, wherein the semicrystalline polymer of the sinterable powder has a melting point that is 20-60° C. lower than the onset temperature of the expandable graphite.

10. The composition of claim 1, wherein the sinterable powder comprises a polyamide (PA), a polyester (PEs), a polyurethane (PU), a polyethyelene (PE), a polypropylene (PP), a poly(butylene terephthalate) (PBT), a poly(etheretherketone) (PEEK), a poly(etherketoneketone) (PEKK), or a combination of two or more of the foregoing.

11. The composition of claim 10, wherein the sinterable powder comprises a polyamide.

12. The composition of claim 10, wherein the polyamide is formed from laurolactam and caprolactam.

13. The composition of claim 12, wherein the proportion of caprolactam is 40-60 mol. % of the total lactams used.

14. The composition of claim 1, wherein the sinterable powder comprises a filler material.

15. The composition of claim 1, wherein the composition is free or substantially free of phosphate.

16. A method of printing a three-dimensional article comprising:
providing a composition comprising a sinterable powder in an amount of 10-99 wt. %, based on the total weight of the composition, and an expandable graphite component in an amount of up to 20 wt. %, based on the total weight of the composition; and
selectively solidifying layers of the composition to form the article.

17. The method of claim 16, wherein the composition is provided in a layer-by-layer process.

18. The method of claim 17, wherein the expandable graphite component is a particulate component having an average particle size in three dimensions that is greater than an average thickness of the solidified layers.

19. The method of claim 18, wherein:
the expandable graphite component has an average particle size in three dimensions of 80-200 μm; and
the solidified layers have an average thickness of 50 μm to 180 μm.

20. The method of claim 16, wherein the article has a v0 or v1 rating according to UL 94V.
